(19) United States
(12) Patent Application Publication
(10) Pub. No.: US 2010/0010285 A1
(43) Pub. Date: Jan. 14, 2010

(54) DECONTAMINATION SYSTEM

(75) Inventors: Von Howard M. Ebron, Springfield, MO (US); Yevgenia V. Ulyanova, Springfield, MO (US); Patrick J. Kinlen, Fenton, MO (US)

Correspondence Address: Nelson Mullins Riley & Scarborough LLP;IP Department, 100 North Tryon Street, 42nd Floor, Charlotte, NC, 28202-4000, US

(73) Assignee: LUMIMOVE, INC., D/B/A CROSSLINK, St. Louis, MO (US)

(21) Appl. No.: 12/491,736

(22) Filed: Jun. 25, 2009

Related U.S. Application Data
(60) Provisional application No. 61/133,181, filed on Jun. 26, 2008.

(51) Int. Cl. A62D 3/38; C01B 15/022; C09K 3/00

(52) U.S. Cl. 588/320; 423/588; 252/186.1

(57) ABSTRACT

A composition including at least one peroxide-generating electrocatalyst, at least one peroxide-activation catalyst, and carbon.

The present application claims priority to U.S. Provisional Patent Application Ser. No. 61/133,181, filed Jun. 26, 2008, incorporated herein by reference in its entirety.

### BACKGROUND OF THE INVENTION

The present invention relates to decontaminating compositions, and more particularly to decontaminating compositions in which the decontaminating effect is non-toxic and non-hazardous.

The need to protect or cleanse surfaces of contaminants is important in many different contexts. It is well known that equipment, floors, walls, counters, and the like, in hospitals and health care facilities must be sanitized regularly. Food service equipment and facilities must be cleaned and sanitized. Certain processing equipment in some manufacturing and/or diagnostic facilities demands a high level of cleanliness and freedom from contaminants.

In a different context, it is important to be able to decontaminate or neutralize chemical and biological warfare agents in order to reduce or avoid grave injury or death of human beings. In this context, the purposeful deployment of extremely aggressive and harmful chemical or biological agents is meant to cause massive contamination of exposed surfaces, which can remain dangerous to living subjects for as long as the harmful agent retains its potency and remains on the surface. Not only are organizations such as the armed forces interested in dealing with such harmful agents, but organizations such as post offices, package delivery services, and the like, are also vigilant to such attacks.

More recently, greater attention has been placed on improved and different techniques and compounds that can be used for the decontamination of surfaces and articles contaminated with chemical and biological warfare agents.

Prior decontamination systems typically contain harsh chemicals that may be unstable in storage, cause personal injury upon skin contact, and severe corrosion of equipment. In addition, although some of these systems are reactive, in many cases they produce chemicals that are as toxic as the chemical and/or biological warfare agent. For example, decontamination systems that employ strong oxidizing agents at high concentrations, such as hydrogen peroxide, bleach, peroxyacetic acid, or mixtures thereof, and that are effective against biological warfare agents, can non-selectively oxidize chemical warfare agents to toxic byproducts that are as hazardous as the agents they are meant to destroy. Other systems employ oxidizing powders that must be mixed with water or other solvents prior to dispensing, leading to logistics and handling difficulties.

### SUMMARY OF THE INVENTION

In one aspect, the present invention is directed to a composition. The composition includes at least one peroxide-generating electrocatalyst, at least one peroxide-activation catalyst, and carbon.

In another aspect, the invention is directed to a method of generating hydrogen peroxide. The method includes providing a composition comprising at least one peroxide-generating electrocatalyst, at least one peroxide-activation catalyst, and carbon, introducing the composition to an environment containing oxygen to generate hydrogen peroxide, and contacting the object with the composition.

In yet another aspect, the invention is directed to a method of decontaminating an object. The method includes providing a composition comprising at least one peroxide-generating electrocatalyst, at least one peroxide-activation catalyst, and carbon, and introducing the composition to an oxygen-containing environment to generate the hydrogen peroxide.

In still another aspect, the invention is directed to a decontamination solution. The solution includes at least one peroxide-generating electrocatalyst, at least one peroxide-activation catalyst, carbon, and at least one polar solvent.

These and other aspects of the invention will be understood and become apparent upon review of the specification by those having ordinary skill in the art.

### DETAILED DESCRIPTION OF THE PREFERRED EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in or are obvious from the following detailed description. It is to be understood by one of ordinary skill in the art that the present discussion is a description of exemplary embodiments only, and is not intended as limiting the broader aspects of the present invention.

In one aspect, the present invention is a composition. The composition includes at least one peroxide-generating catalyst, at least one peroxide-activation catalyst, and carbon. The present composition may have applications, when combined with water or another polar solvent, as a decontaminating solution. The decontaminating solution, when applied to a surface in an environment containing oxygen generates hydrogen peroxide and/or activated hydrogen peroxide. The hydrogen peroxide and/or activated hydrogen peroxide may then act to neutralize contaminants on the surface, resulting in the production of non-toxic and non-hazardous by-products.

As used herein, the term “non-toxic” means not poisonous to animal or plant life. Also as used herein, the term “non-hazardous” means not harmful (i.e., safe) to animal or plant life.

The present composition can be applied to a surface before or after contamination occurs. The composition can be adapted to be used on surfaces of almost any type of substrate. Examples of substrates on which the present composition may be applied include metal, plastic, wood, fabric, glass, ceramic, composites, skin, or a mixture of any of these. The present compositions and methods may be particularly useful when applied to the surfaces of flexible substrates, such as fabrics and plastic films. In these applications, the present composition can be applied to clothing, tents, protective shelters, and the like.

Although almost any substrate is suitable for use with the present compositions and methods, exemplary substrates have a surface that is subject to contamination, such as a surface that is exposed to the environment. The substrate can be hard, soft, or of almost any texture, and can be composed of almost any material, including, without limitation, metal, plastic, polymers, wood, fabric, clay, fibers, paper, skin, composites, or the like. Substrates on which the present compositions and methods are commonly useful include tents, protective coverings and shelters, outer surfaces of vehicles and equipment that may be exposed to harmful agents, such as nerve gases, toxins, and biological warfare agents, and surfaces for which cleanliness and sterility are important, such as on food preparation and food service equipment and hospital and health service equipment. Furthermore, the compositions and methods of the present invention can be applied over almost any pre-coat that has been applied to a substrate surface, such as a paint.

When the term “surface”, or “surfaces”, is used herein in relation to a substrate—a material or article on which the subject composition is placed—it means any surface of the material or article that is subject to contamination and of which decontamination is desired. These surfaces are commonly outer surfaces, that is, surfaces of the material or article that are exposed to the surrounding environment.

As used herein, the term “contaminant” means any chemical or biological compound, constituent, species, or agent that through its chemical or biological action on life processes can, if left untreated, cause death, temporary incapacitation, or permanent harm to humans or animals. This includes all such chemicals or biological agents, regardless of their origin or of their method of production. The present method and coating is useful for the decontamination of surfaces that are contaminated with chemical and/or biological warfare agents, as well as with common bacteria, viruses, fungi, or other undesirable chemicals, toxins, or living organisms. Biological warfare agents that can be decontaminated and/or destroyed by the present invention include, without limitation, bacteria, viruses and fungi, including vegetative and spore forms. These include organisms that produce, or are the causative organisms for, anthrax, smallpox, plague, botulinum toxin, and other diseases. Also included are the chemical toxins that are produced by the organisms.

As used herein, the term “decontaminate” means to change a contaminant from a form or an amount that is harmful to a human or an animal to a form or an amount that is less harmful to the human or animal by any degree. When a contaminant is decontaminated, it may be rendered substantially harmless to humans or animals that come into contact with it after decontamination is completed or the degree of harmfulness may simply be reduced. When used herein in the context of decontamination of a contaminant, the term “destroy” means the modification of the chemical structure of the contaminant to a chemical form that is less harmful to humans or animals than the original structure, and the term “neutralize” means the combination of the contaminant with another compound or material results in binding or diluting the contaminant, or otherwise renders it less available to harmful interaction with the biological system of a human or animal with which it comes in contact.

Chemical warfare agents that may be decontaminated and/or destroyed by the present invention include, but are not limited to, types of nerve gas G, such as the o-alkyl phosphonofluoridates, sarin (GB) and soman (GD), and o-alkyl phosphoramidocyanidates, such as tabun (GA); types of nerve gas V, such as o-alkyl, s-2-dialkyl aminoethyl alkylphosphonothiolates and corresponding alkylated or protonated salts, such as VX; vesicants, such as the mustard compounds, including 2-chloroethylchloromethylsulfide, bis(2-chloroethyl)sulfide, bis(2-chloroethylthio)methane, 1,2-bis(2-chloroethylthio)ethane, 1,3-bis(2-chloroethylthio)-n-propane, 1,4-bis(2-chloroethylthio)-n-butane, 1,5-bis(2-chloroethylthio)-n-pentane, bis(2-chloroethylthiomethyl)ether, and bis(2-chloroethylthioethyl)ether; Lewisites, including 2-chlorovinyldichloroarsine, bis(2-chlorovinyl)chloroarsine, tris(2-chlorovinyl)arsine, bis(2-chloroethyl)ethylamine, and bis(2-chloroethyl)methylamine; saxitoxin, ricin, alkyl phosphonyidifluoride, alkyl phosphonites, chlorosarin, chlorosoman, amiton, 1,1,3,3,3,-pentafluoro-2-(trifluoromethyl)-1-propene, 3-quinuclidinyl benzilate, methylphosphonyl dichloride, dimethyl methylphosphonate, dialkyl phosphoramidic dihalides, dialkyl phosphoramidates, arsenic trichloride, diphenyl hydroxyacetic acid, quinuclidin-3-ol, dialkyl aminoethyl-2-chlorides, dialkyl aminoethan-2-ols, dialkyl aminoethane-2-thiols, thiodiglycols, pinacolyl alcohols, phosgene, cyanogen chloride, hydrogen cyanide, chloropicrin, phosphorous oxychloride, phosphorous trichloride, phosphorus pentachloride, alkyl phosphites, sulfur monochloride, sulfur dichloride, and thionyl chloride.

The present compositions include at least one peroxide-generating electrocatalyst. As used herein, an electrocatalyst is to be understood to be a compound or molecule which facilitates the transfer of electrons and hydrogen ions to oxygen and which promotes the formation of hydrogen peroxide. The electrocatalyst may be a compound that can be reversibly oxidized and reduced. Examples of useful electrocatalysts for the present coating and method include substituted or unsubstituted quinones, including naphthoquinones and anthraquinones.

Specific examples of useful quinone electrocatalysts include 2,6-dihydroxyanthraquinone (DHAQ), 2,3-dichloro-1,4-naphthoquinone (DCNQ), aminoanthraquinone (AAQ), tetrabromo-p-benzoquinone (TBBQ), 6,13-pentacenequinone (PAQ), 2-amino-3-chloro-1,4-naphthoquinone (ACNQ), phenanthrenequinone (PTQ), anthraquinone (AQ), and the substituted anthraquinones:

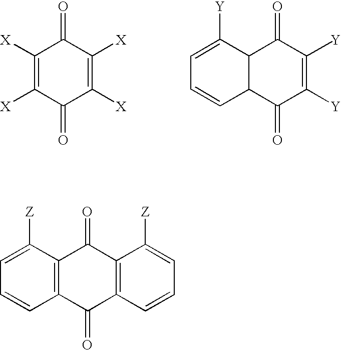

where X is one or more of H, Br; Y is one or more of H, NH₂, Cl, —OH; and Z is one or more of H, —OH, and —NH₂; and combinations thereof. Mixtures of any of these can also be used. TBBQ and DHAQ may be exemplary electrocatalysts.

In exemplary embodiments, the peroxide-generating catalyst comprises from about 0.1% to about 1% by weight of the present composition, in some embodiments, from about 0.1% to about 0.5%, in other embodiments, from about 0.2% to about 0.4%.

Decontaminating agents of the present invention are formed when the composition is introduced to an environment including oxygen. The decontaminating agents include hydrogen peroxide and one or both of its deprotonated forms, with activated hydrogen peroxide being exemplary. Activated hydrogen peroxide is typically hydrogen peroxide or one of its anionic forms bound to a peroxide activation catalyst. While not intending to be bound by theory, it is believed that the resulting complex of the peroxide with the peroxide activation catalyst is better able to decontaminate and/or destroy contaminants through one or more of the following reactions: peroxidation, oxidation, perhydrolysis, and hydrolysis.

In order to obtain activated peroxide, at least one peroxide activation catalyst is included in the present composition. The activation catalyst may be water soluble. Examples of useful peroxide activation catalysts include complexes of ethylenediaminetetraacetic acid with metals such as iron (EDTA/Fe complexes), tetraamidomacrocyclic ligand (TAML®) complexes with metals such as iron (TAML®/metal complexes are exemplified by the compounds described in U.S. Pat. Nos. 5,847,120, 6,051,704, 6,011,152, 6,100,394 and 6,054,580, each incorporated herein by reference in their entirety, and are available from Carnegie Mellon University), manganese gluconate, sodium hypochlorite, N-[4-(triethylammoniomethyl)benzoyl]-caprolactam chloride, nonanoyloxybenzene sulfonate, porphyrins, phthalocyanines, ruthenium oxide, indium oxide, quinones, and the like. Peroxide activation catalysts of the present invention include TAML®/metal complexes, and TAML®/Fe complexes. Examples of exemplary TAML®/metal complexes are shown in the table below:

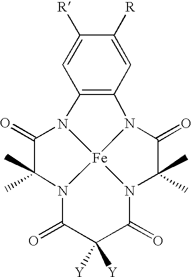

| Y | R′/R | Name |
|---|---|---|
| F | H/NO₂ | Fe—NO₂BF₂ |
| CH₃ | H/Methyl ester | Fe-MeEB* |
| CH₃ | H/NO₂ | Fe—NO₂B* |
| CH₃ | H/Acid | Fe-AcidB* |
| F | H/Acid | Fe-AcidBF₂ |
| F | H/Ethyl ester | Fe-EEBF₂* |
| CH₃ | H/H | FeB* |

In exemplary embodiments, the peroxide-activation catalyst comprises from about 0.01% to about 0.2% by weight of the present composition, in some embodiments, from about 0.01% to about 0.1%, in other embodiments, from about 0.1% to about 0.2%.

The present composition further includes carbon. The carbon may be in the form of carbon black, activated carbon black, carbon fibers, carbon powders, carbon nanomaterials, carbon/polymer blends, or combinations thereof. One having ordinary skill in the art will recognize that carbon materials listed above are available in a multitude of grades, sizes, and purities. Exemplary carbon materials include high surface area carbon materials known in the art.

In some embodiments, it may be desirable to treat the carbon with an acid prior to forming the present composition. The acid may enhance the hydrophilicity of the carbon materials. For example, the carbon may be treated with dilute (e.g., from 1-20%) aqueous acid solutions. Exemplary acids contemplated as useful include one or more of nitric acid, sulfuric acid, hydrochloric acid, phosphoric acid, and other common inorganic acids.

In exemplary embodiments, the carbon comprises from about 1% to about 10% by weight of the present composition, in some embodiments, from about 1% to about 5%, in other embodiments, from about 2% to about 4%.

It may be desirable to immobilize the peroxide-generating electrocatalysts discussed above to the carbon materials. The peroxide-generating electrocatalysts, or their derivatives, may be deposited or mixed at different loadings onto the carbon materials discussed above through any method that affixes the electrocatalyst to the carbon material in such a way that it does not impair the electron transfer function of the molecule. Such immobilization techniques include, but are not limited to, one or more of physical absorption, electrochemical deposition through covalent attachment, physical adsorption, or physical mixing/blending. In some embodiments, it may be desirable to treat the resulting carbon/electrocatalyst system with dilute acids, such as those discussed above. In other embodiments, it may be desirable to treat the carbon materials with dilute acid before immobilization of the peroxide-generating catalyst.

When the electrocatalyst is a quinone electrocatalyst, the quinone can be physically adsorbed onto the carbon material by treating the carbon surface with a mineral acid, such as nitric acid, followed by treating with a base, such as sodium hydroxide or potassium hydroxide, then washing with water, and contacting the washed carbon material with a solution of the desired quinone in a suitable solvent under conditions of time, temperature, and pH sufficient for the quinone to adsorb onto the surface of the carbon. After washing, the quinone-coated carbon material is ready for use in the present compositions and methods.

In another embodiment, the electrocatalyst, such as quinones, can be mixed with carbon powder in a liquid, such as hexanes. Mixing can be accomplished by high intensity mixing, such as sonication. The dispersion may be dried and then used in the present compositions and methods.

In yet another embodiment, a quinone may also be intermixed with carbon powder in the presence of a binder, such as 10% by weight NAFION® solution, available from Sigma Aldrich, in a solvent, such as 2-propanol. After mixing the binder with the quinone and carbon powder, the solvent can be evaporated to produce a blended powder. The resulting powder may then be used in the present compositions and methods.

In a different embodiment, the electrocatalyst may be immobilized onto carbon fibers. Covalently attached quinones are less likely to desorb from the fibers during use, and much higher quinone loadings may be obtained on carbon fiber, as opposed to quinone loading on, for example, glassy carbon, due to the greater surface area per unit weight of the carbon fibers. Carbon fibers having covalently attached quinone electrocatalysts may generate higher concentrations of hydrogen peroxide than glassy carbon. Moreover, carbon fibers having covalently bound quinone electrocatalysts may generate twice the amount of peroxide as pristine carbon fibers absent the attached quinone.

Covalent attachment of a quinone electrocatalyst to a carbon electrode can be accomplished by any of the methods described by Schiffrin et al., J. of Electroanal. Chem., 515:101 (2001), Schiffrin et al., J. of Electroanal. Chem., 564:159 (2004), Schiffrin et al., J. of Electroanal. Chem., 541:23 (2003), Kullapere et al., Electrochem. Commun., 9(5):1196-1201 (2007), Pandurangappa, M. et al., Analyst, 127:1568 -1571 (2002), or Vaik et al., Electrochi. Acta, 50(25-26):5126-5131 (2005).

In some embodiments, it may be desirable to include a surfactant in the present composition to improve the hydrophilicity of the composition. Surfactants contemplated as useful include one or more of lithium dodecylsulfate, sodium dodecylsulfate,

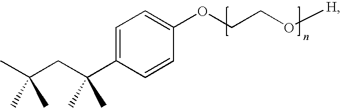

### and Triton-X.

The present composition may further include at least one polar solvent, such as water, alcohols, other environmentally safe polar solvents, and combinations thereof. In some embodiments, where the polar solvent is water, the water is deionized and/or distilled. In exemplary embodiments where a polar solvent is included, the polar solvent comprises from about 80% to about 97% by weight of the present composition, in some embodiments, from about 80% to about 90%, in other embodiments, from about 90% to about 97%.

It may be desirable to include other additives in the present composition. Exemplary additives may include, but are not limited to, one or more of biocides, gemicides, anti-flocculants, viscosity modifiers, leveling agents, and other common coating formulation additives.

In another aspect, the invention is a method of generating hydrogen peroxide. The method includes providing a composition comprising at least one peroxide-generating electrocatalyst, at least one peroxide-activation catalyst, and carbon, and introducing the composition to an oxygen-containing environment to generate hydrogen peroxide.

Without being bound by theory, a proposed mechanism of hydrogen peroxide generation in accordance with one embodiment of the present invention is:

Activated Carbon+TBBQ+Acid→TBBHQ (hydroquinone derivative) TBBHQ+O₂→H₂O₂+TBBQ

When the hydrogen peroxide-activation catalyst is also included in the above equation, the resulting hydrogen peroxide may be activated.

The present invention provides a method for spontaneous hydrogen peroxide generation without the requirement of an electric current or voltage. As is known to those having ordinary skill in the art, the prior art methods of forming hydrogen peroxide, including activated hydrogen peroxide, with the use of quinones typically requires a current or voltage to produce the hydrogen peroxide. The present method does not require the use of an electric current or voltage, resulting in fewer components and more flexibility of use of the system.

In another aspect, the invention is directed to a method of decontaminating an object. The method includes providing a composition having at least one peroxide-generating electrocatalyst, at least one peroxide-activation catalyst, and carbon, introducing the composition to an environment containing oxygen to generate hydrogen peroxide, and contacting the object with the composition. In some embodiments, the step of introducing the composition to an environment containing oxygen and the step of contacting the object are conducted substantially simultaneously. In other embodiments, the composition may be introduced to an oxygen containing environment prior to contacting the object with the composition. In yet other embodiments, the composition may be contacted to the object prior to the introduction of an oxygen-containing environment.

The present method may be utilized in ambient air. Additionally, the present method may be utilized in controlled environments with controlled oxygen levels. Moreover, the present method is suitable for using in extreme environments, such as high temperatures and very low temperatures. In some embodiments, the present method and system may be utilized in combat environments, such as battlefields. In other embodiments, the present method may be used on airplanes or helicopters during flight or on the ground. In still other embodiments, the present invention may be used on devices and objects used in space.

The composition may be contacted to the object by methods known in the art, including spraying, brushing, pouring, dipping, flow-coating, spin-coating, soaking, and other common coating methods.

The present system generates activated peroxide upon exposure to oxygen in ambient air and may be packaged into non-CFC aerosol spray cans using nitrogen or another inert gas for pressurization. To employ, the system may be sprayed onto a contaminated surface, at which time oxygen from the air is spontaneously converted “on-site” to hydrogen peroxide and/or activated hydrogen peroxide that selectively and controllably decontaminates and/or destroys chemical and/or biological warfare agents. As used herein, the term “spontaneous” means without electric current or voltage.

Of particular note is that the system converts chemical and/or biological warfare agents to nontoxic byproducts. For example, sulfide-based chemical warfare agents such as sulfur mustard may be substantially quantitatively converted to nontoxic sulfoxides, thereby circumventing the production of toxic sulfones. Furthermore, the system does not require storage of concentrated peroxides or other hazardous chemicals. Finally, because the system is catalytic, it is regenerable for the life of the catalyst—often over 100,000 cycles—so that only small amounts of spray are needed to decontaminate and/or destroy large amounts of chemical and/or biological warfare agent.

A sample conversion of mustard gas and a surrogate for VX agent using the present system and prior art systems is shown below. The use of non-catalytically activated peroxides often results in the formation of a mixture of oxidation products, including toxic sulfones, whereas the present system described herein results in quantitative conversion to non-toxic sulfoxide by-products.

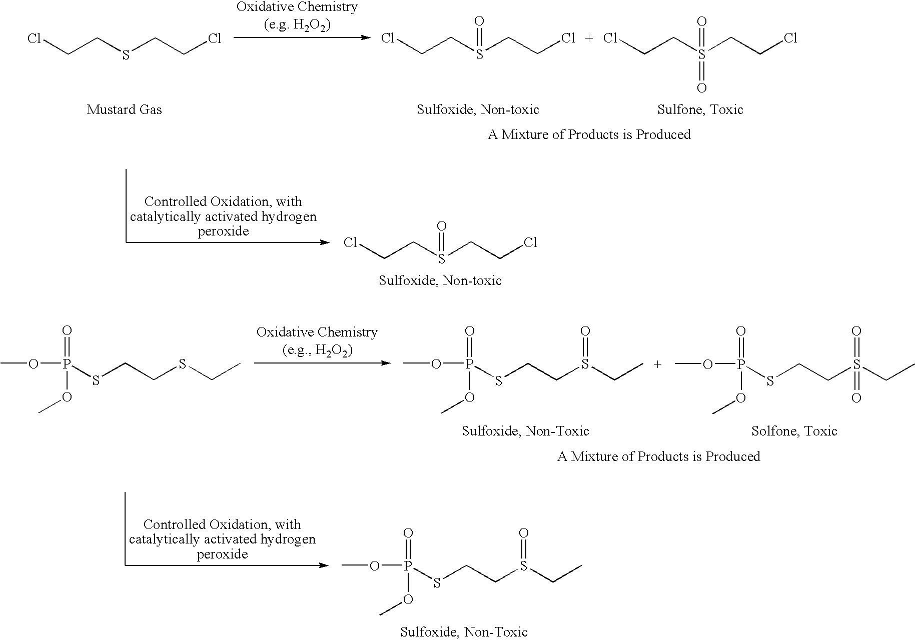

The present composition provides a non-hazardous, water-based system that can be rapidly dispensed to safely, efficiently, and substantially quantitatively decontaminate and/or destroy chemical and/or biological warfare agents after an attack on personnel and equipment. The present invention provides an inexpensive, easily understood and operated delivery system that minimizes environmental and user impact through the use of non-hazardous carrier solvents and minimal volume requirement.

Moreover, the present composition is formulated using inexpensive ingredients and has no requirement to store hazardous chemicals, such as concentrated hydrogen peroxide or hypochlorite.

As more fully discussed above, the present composition provides substantially quantitative detoxification of a broad base of both chemical and biological agents, while generating only non-toxic byproducts or vapors over a range of temperatures, including temperatures in extreme environments, such as deserts.

Advantageously, the present composition is not harmful to skin, wood, plastics, composites, metals, polymers, textiles, and common paints and coatings. The composition may be used, therefore, on a wide variety of substrates (as discussed above) that may be exposed to such harmful contaminants.

The present system does not require storage of concentrated peroxides or other hazardous chemicals. Furthermore, because the system is catalytic, it is regenerable for the life of the catalyst—often over 100,000 cycles—so that only small amounts of spray are needed to decontaminate and/or destroy large amounts of chemical and/or biological warfare agent. Additionally, of particular note is that the system converts chemical and/or biological warfare agents to nontoxic byproducts. For example, sulfide-based agents such as sulfur mustard will be quantitatively converted to nontoxic sulfoxides, thereby circumventing the production of toxic sulfones.

Due to the inherent versatility of the present decontamination system, it is useful for the decontamination and/or destruction of a wide variety of both chemical and biological agents, including toxic industrial chemicals, chemical warfare agents such as nerve and blister agents, and biological agents such as anthrax spores and bacteria. In certain embodiments, the present compositions may include one or more of the following attributes:
Versatility—A wide variety of chemical agents and microorganisms may be destroyed and detoxified with the present system.
Shelf-stability—Since peroxide is rapidly generated upon exposure to air, no storage of concentrated hydrogen peroxide or other dangerous chemicals is required.
Small footprint—Compared to previously developed systems, the present system will use less volume and require less storage space than conventional spray-on decontamination systems. It is lightweight and extremely portable, all because of the highly active catalyst that generates activated peroxide directly on the surface being decontaminated. The catalyst is regenerable, so a small amount is used to generate an effective decontaminant.
Environmental friendliness—the solvent is water, and additives and catalysts (as discussed above) minimize environmental and user impact. Since nontoxic byproducts are produced from the decontamination process, the cleanup and disposal of post-decontamination residues is simplified.
Ease of use—the system may be packaged in standard, easy-to-use non-CFC aerosol spray cans pressurized with nitrogen or another inert gas.
Commercial potential—the system may also be of interest to customers in the industrial, healthcare, and public safety fields. This broad applicability provides a high degree of commercial potential.

The following examples describe exemplary embodiments of the invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples. In the examples all percentages are given on a weight basis unless otherwise indicated.

Spontaneous H₂O₂ generation (generation without application of electric current or voltage) was observed when H₂O₂ was detected on control devices to which electric current or voltage was applied and devices where electric current or voltage was not applied. Without being bound by theory, this process was attributed to the acid treatment conducted on the carbon-based substrates containing tetrabromobenzoquinone (TBBQ) used as an electrocatalyst for H₂O₂ generation. H₂O₂ determination was performed using the Hach Kit Titration Method. The polymer gel electrolyte (PGE) used was a mixture of polyethylene oxide (PEO), Polyvinylalcohol-co-amine, M12 (PVA-co-Am, medium molecular weight), 1-butyl-3-methylimidazolium hexafluorophosphate (BMIPF₆), and polycup 172 crosslinker.

### EXAMPLE 1

This example demonstrates the spontaneous generation of hydrogen peroxide on activated carbon fabric (ACF, Spectracarb) without washing.

Four pieces of ACF (3.5×3.5 cm) were placed in 20 mL of 1 M HNO₃ in order to verify the hypothesis of spontaneous generation of H₂O₂ by carbon material. From this mixture, aliquots (2 mL) were taken at different time increments (5, 10, 15, 30, and 60 minutes) and the H₂O₂ concentration analyzed by Hach kit titration (Table 1). It was found that H₂O₂ was present in the acid treatment solution at shorter periods of time without the washing step.

TABLE 1
Activated carbon fabric (ACF, Spectracarb), surface
area 2500 m²/g - without washing with water

| | Volume used for | |
|---|---|---|
| Time (min) | Hach kit titration (mL) | [H₂O₂] (mM) |
| 5 | 0.1 | 0.091 |
| 10 | 0.05 | 0.023 |
| 15 | 0.05 | 0.023 |
| 30 | 0.05 | 0.023 |
| 60 | 0.05 | 0.023 |

To incorporate TBBQ in ACF, ACF of the same size as described above was placed in 20 mM ethanol solution of TBBQ for 20 hours. The TBBQ-treated ACF pieces were removed from TBBQ solution and oven dried for 1 h. The TBBQ-ACF pieces were placed in 20 mL of 1M HNO₃. Similarly, aliquots (2 mL) were taken at different time increments (5, 10, 15, 30, and 60 minutes) and analyzed for H₂O₂ presence using Hach kit titration (Table 2). Results show that the amount of H₂O₂ which was spontaneously generated on TBBQ-ACF is higher compared to when ACF was used alone. This result shows the catalytic effect of the quinone used.

TABLE 2
TBBQ-ACF (surface area 2500 m²/g) - without washing with water

| | Volume used for | |
|---|---|---|
| Time (min) | Hach kit titration (mL) | [H₂O₂] (mM) |
| 5 | 0.25 | 0.29 |
| 10 | 0.25 | 0.29 |
| 15 | 0.25 | 0.29 |
| 30 | 0.25 | 0.29 |
| 60 | 0.2 | 0.22 |

### EXAMPLE 2

This example demonstrates the spontaneous generation of hydrogen peroxide on activated carbon fabric (ACF, Spectracarb) under an argon atmosphere and an oxygen atmosphere.

A 7 cm×8 cm sample of ACF was cut into four pieces. The four pieces were placed into a two-neck flask and evacuated over night at room temperature. Then the flask was evacuated further at elevated temperatures (heat gun). At the same time, argon was bubbled through 1 M HNO₃ for 30 min. Using a syringe, 20 mL HNO₃ was withdrawn and injected into the flask containing the ACF. At different times (10, 15, 30, and 60 min) and with flowing argon, a glass pipette was introduced into the flask to withdrew 2 mL liquid from the mixture for analysis (Table 3).

TABLE 3
ACF in acid under argon/vacuum conditions

| | Volume used for | |
|---|---|---|
| Time (min) | titration (mL) | [H₂O₂] (μM) |
| 10 | 0.10 | 91.5 |
| 15 | 0.12 | 118.7 |
| 30 | 0.10 | 91.5 |
| 60 | 0.11 | 105.1 |

Results show that H₂O₂ can be generated under argon atmosphere and in the same range as the concentrations obtained under ambient conditions. The generation of H₂O₂ using activated carbon fabric in the presence of acid could be due to the type of carbon material used. Since the carbon type used is activated, the production of H₂O₂ in the presence of acid could occur on the oxygen sites available on the carbon surface.

In another experiment, two pieces of ACF were treated with acid (60 mL, 1M HNO₃) under O₂ atmosphere. Aliquots (4 mL) were taken at different periods (5, 10, 15, 30, 60, and 180 minutes) and analyzed (Table 4). Results show H₂O₂ concentrations similar to when H₂O₂ was generated under ambient and argon conditions, which indicate that the presence of oxygen sites in the activated carbon affects the generation process more than the environmental conditions (ambient, Ar, and O₂ conditions).

TABLE 4
Activated carbon fabric (ACF, Spectracarb),
surface area 2500 m²/g - under O₂ atmosphere

| | Volume used for | |
|---|---|---|
| Time (min) | Hach kit titration, (mL) | [H₂O₂] (mM) |
| 5 | 0.2 | .11 |
| 10 | 0.25 | .14 |
| 15 | 0.25 | .14 |
| 30 | 0.25 | .14 |
| 30 | 0.3 | .18 |
| 180 | 0.25 | .14 |

### EXAMPLE 3

This example demonstrates spontaneous H₂O₂ on spray-coated carbon and carbon powder, (TBBQ-carbon powder treated with HNO₃)—under ambient conditions.

Carbon powder (Raven 1040 beads, Columbian Chemicals Co.) was mixed with TBBQ (10:1) and dispersed in 30 mL of hexane. General purpose fabric (GPF) was spray-coated with this mixture. GPF was also sprayed with carbon powder dispersed in hexane without TBBQ and was used as a control. 1.5×1.5 cm pieces were cut and placed in 1M HNO₃ for different periods of time (from 5 minutes to 1 hour). Titration of the acid solution by Hach kit showed that no H₂O₂ was present. This could be due to the exposure of less carbon surface area of the spray-coated film compared to when powder is used.

A 200 mg sample of carbon powder was soaked in 5 mL, 1M HNO₃ solution for 15, 30, 45, and 60 minutes. A different carbon powder sample was used at each time interval. Following each time interval, the carbon powder was separated from the HNO₃ solution by filtration. Hach kit titration was performed on a 2 mL sample of the HNO₃ filtrate to determine the concentration of H₂O₂ formed in the presence of carbon powder and acid (Table 5). Higher concentrations were obtained from carbon powder compared to activated carbon fabric. This could be due to the higher surface area of the carbon powder, allowing more active sites for spontaneous H₂O₂ generation.

TABLE 5
Carbon powder treated with HNO₃ - under ambient conditions

| | Volume used for | |
|---|---|---|
| Time (min) | titration (mL) | [H₂O₂] (μM) |
| 15 | 0.24 | 282.0 |
| 30 | 0.57 | 731.1 |
| 45 | 0.49 | 622.2 |
| 60 | 0.46 | 581.4 |

Similarly, using the same experimental procedure, 200 mg of a 10:1 carbon powder:TBBQ mixture was soaked in 1 M HNO₃ for 15, 30, 45, and 60 minutes. H₂O₂concentrations obtained from carbon powder:TBBQ at 10:1 ratio did not show any catalytic effect (Table 6)

TABLE 6
Carbon powder:TBBQ (10:1) treated with
HNO₃ - under ambient conditions

| | Volume used for | |
|---|---|---|
| Time (min) | titration (mL) | [H₂O₂] (μM) |
| 15 | 0.08 | 64.2 |
| 30 | 0.44 | 554.2 |
| 45 | 0.41 | 513.3 |
| 60 | 0.44 | 554.2 |

Control experiments were also performed using carbon powder or carbon powder:TBBQ soaked in pH 7 water (no acid) for 60 minutes. Aliquots taken from these samples demonstrated that H₂O₂ is not present. Also, no H₂O₂ was initially present in the 1M HNO₃ solution.

### EXAMPLE 4

This example demonstrates the spontaneous generation of H₂O₂ on carbon powder and TBBQ-carbon powder treated with HNO₃—under argon conditions

TABLE 7
Carbon powder treated with HNO₃ - under argon/vacuum conditions

| | Volume used for | |
|---|---|---|
| Time (min) | titration (mL) | [H₂O₂] (μM) |
| 15 | 0.20 | 227.5 |

Carbon powder and the 10:1 carbon powder:TBBQ mixture were also acid-treated under inert atmosphere. 400 mg of carbon powder (or carbon:TBBQ mixture) was placed in a three-neck flask with rubber stoppers. A filtration assembly was placed inside the flask. The flask was evacuated for 4 h and then refilled with argon for the carbon powder sample. In the carbon:TBBQ mixture, argon was continuously purging the flask for 30 min to replace air. Argon was bubbled in 1 M HNO₃ for 30 min. A glass syringe was used to withdraw 10 mL HNO₃, which was injected into the flask to mix with the carbon powder (or carbon:TBBQ mixture). At different times and with flowing argon, a glass pipette was used to withdraw the carbon-acid suspension. The suspension was injected into the filter to remove particles. The withdrawing and injection procedure were repeated to collect 5 mL clear solution, 2 mL of which was analyzed by Hach kit titration method (Tables 7 and 8). As previously discussed, H₂O₂ was generated using acid-treated carbon under both ambient and argon conditions and TBBQ did not show catalytic effect when mixed with carbon powder.

TABLE 8
Carbon powder:TBBQ treated with HNO₃ - under argon conditions

| | Volume used for | |
|---|---|---|
| Time (min) | titration (mL) | [H₂O₂] (μM) |
| 15 | 0.16 | 173.1 |
| 30 | 0.49 | 622.2 |
| 45 | 0.43 | 540.6 |

JMP software using the Variability Gage function summarizes results from H₂O₂ generation experiments on acid-treated ACF and carbon powder materials.

All references cited in this specification, including without limitation all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinency of the cited references.

In view of the above, it will be seen that the several advantages of the invention are achieved and other advantageous results obtained.

As various changes could be made in the above methods and compositions without departing from the scope of the invention, it is intended that all matter contained in the above description and shown in the accompanying drawings shall be interpreted as illustrative and not in a limiting sense.

What is claimed is:

1 A composition comprising:
at least one peroxide-generating electrocatalyst;
at least one peroxide-activation catalyst, and carbon.

2. The composition according to claim 1, wherein the peroxide-generating electrocatalyst is a quinone electrocatalyst.

3. The composition according to claim 2, wherein the quinone electrocataylst is selected from one or more of 2,6-dihydroxyanthraquinone (DHAQ), 2,3-dichloro-1,4-naphthoquinone (DCNQ), aminoanthraquinone (AAQ), tetrabromo-p-benzoquinone (TBBQ), 6,13-pentacenequinone (PAQ), 2-amino-3-chloro-1,4-naphthoquinone (ACNQ), phenanthrenequinone (PTQ), anthraquinone (AQ), and the substituted anthraquinones: 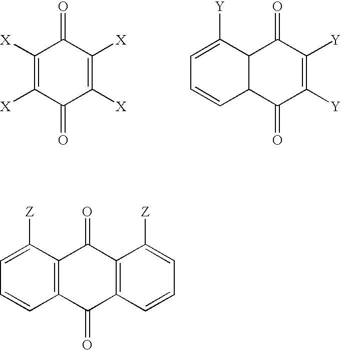
where X is one or more of H, Br; Y is one or more of H, NH₂, Cl, —OH; and Z is one or more of H, —OH, and —NH₂; and combinations thereof.

4. The composition according to claim 1, wherein the peroxide-activation catalyst comprises at least one tetraamidomacrocyclic ligand complex.

5. The composition according to claim 1, wherein the carbon comprises one or more of carbon black, carbon fiber, carbon nanomaterials, and activated carbon.

6. The composition according to claim 1, wherein the carbon is pretreated with acid.

7. The composition according to claim 6, wherein the acid is selected from one or more of nitric acid, sulfuric acid, and hydrochloric acid.

8. The composition according to claim 1, wherein the peroxide-generation electrocatalyst is immobilized on the carbon.

9. The composition according to claim 1, wherein the composition comprises from about 0.1% by weight to about 1% by weight peroxide-generating electrocatalyst.

10. The composition according to claim 1, wherein the composition comprises from about 0.01% to about 0.2% by weight peroxide-activation catalyst.

11. The composition according to claim 1, wherein the composition comprises from about 1% to about 10% by weight carbon.

12. A method of decontaminating an object, the method comprising:
providing a composition comprising:
at least one peroxide-generating electrocatalyst;
at least one peroxide-activation catalyst, and carbon;
introducing the composition to an environment containing oxygen to generate hydrogen peroxide; and
contacting the object with the composition.

13. The method according to claim 12, wherein the step of introducing the composition to an environment containing oxygen and the step of contacting the object with the composition are conducted substantially simultaneously.

14. The method according to claim 12, wherein the step of introducing the composition to an environment containing oxygen is conducted prior to the step of contacting the object with the composition.

15. The method according to claim 12, wherein the step of introducing the composition to an environment containing oxygen is conducted after the step of contacting the object with the composition.

16. A method of generating hydrogen peroxide, the method comprising
providing a composition comprising:
at least one peroxide-generating electrocatalyst;
at least one peroxide-activation catalyst; and
carbon; and
introducing the composition to an oxygen-containing environment to generate the hydrogen peroxide.

17. The method according to claim 16, wherein the oxygen-containing environment is ambient air.

18. A decontamination solution comprising:
at least one peroxide-generating electrocatalyst;
at least one peroxide-activation catalyst,
carbon; and
at least one polar solvent.
